(19) United States
(12) Patent Application Publication
(10) Pub. No.: US 2011/0275373 A1
(43) Pub. Date: Nov. 10, 2011

(54) USER EQUIPMENT SUPPORTING MULTIPLE MOBILE COMMUNICATION SYSTEMS AND CELL SELECTION METHOD FOR THE SAME

(75) Inventor: Beom Yong LEE, Yongin-si (KR)

(73) Assignee: SAMSUNG ELECTRONICS CO. LTD., Suwon-si, Gyeonggi-do (KR)

(21) Appl. No.: 13/094,069

(22) Filed: Apr. 26, 2011

(30) Foreign Application Priority Data
May 10, 2010 (KR) 10-2010-0043393

(51) Int. Cl. H04W 8/02

(52) U.S. Cl. 455/435.2

(57) ABSTRACT

A user equipment supporting multiple communication systems and a cell selection method for the same are provided. The cell selection method, for a user equipment supporting first and second systems, includes storing records of services received by the user equipment in a service log, receiving, by the user equipment, a service from a reference cell of the first system, extracting, by the user equipment which waits to receive a service from the second system during service reception from the reference cell, a cell frequency band of the second system corresponding to identification information of the reference cell from the service log, and performing, when extraction of a cell frequency band of the second system is successful, cell acquisition using the extracted cell frequency band. The user equipment supporting different communication systems may thereby perform cell selection in an improved manner.

### PRIORITY

This application claims the benefit under 35 U.S.C. §119(a) of a Korean patent application filed on May 10, 2010 in the Korean Intellectual Property Office and assigned Serial No. 10-2010-0043393, the entire disclosure of which is hereby incorporated by reference.

### BACKGROUND OF THE INVENTION

1. Field of the Invention

The present invention relates to a user equipment supporting multiple mobile communication systems. More particularly, the present invention relates to a cell selection method that enables the user equipment to effectively perform cell selection in consideration of intercell overlap.

2. Description of the Related Art

The Long Term Evolution (LTE) system, as a next generation mobile communication system, attempts to provide various multimedia services based on packet data transmission. The LTE system supports a maximum bandwidth of 20 megahertz (MHz), and provides a downlink data rate of 100 million bits per second (Mbps) and an uplink data rate of 50 Mbps. The LTE system employs Orthogonal Frequency Division Multiplexing (OFDM) to efficiently utilize radio resources, uses Multiple Input Multiple Output (MIMO) technology for high data transfer performance, supports high-speed mobility and low round trip latency, and provides other techniques to meet Quality of Service (QoS) requirements optimized for packet data transmission. More particularly, the LTE system is defined by the 3rd Generation Partnership Project (3GPP) specification (Release-8) and is backward compatible with earlier systems.

In Universal Mobile Telecommunications System (UMTS) and Release-8 LTE, cell selection for inter-system handover is performed using neighbor cell information that is transmitted as system information. For example, when a user equipment being served by a 3rd Generation (3G) cell A moves to a region covered by a 2nd Generation (2G) cell B, the user equipment uses system information received from the 3G cell A to perform cell selection. If the system information indicates the 2G cell B as a neighbor cell, the user equipment may check the status of radio links and select the 2G cell B if selection conditions are satisfied.

However, such cell selection is possible only when different systems meet the same network specification. For example, when two neighbor cells (3G cell C and LTE cell D) meet the Release-8 specification, a user equipment may receive information on the LTE cell D from the 3G cell C and use the received information for cell selection.

When the 3G cell C conforms to the Release-6 specification and the LTE cell D conforms to the Release-8 specification, system information provided by the 3G cell C does not contain information on the LTE cell D as neighbor cell information. In this case, as information on the LTE cell D is not present in system information from the 3G cell C, the user equipment having received the system information from the 3G cell C may fail to select the LTE cell D even though it remains in a region covered by the LTE cell D. To select the LTE cell D, the user equipment may have to perform cell search over a wide frequency range. This may cause a rise in power consumption depending on search cycles and it may be difficult to find an optimal search cycle.

More particularly, a user equipment being served by an LTE system uses Circuit Service (CS) fallback to handle a voice call with a different system such as a 2G or 3G system. In CS fallback, the user equipment sends an extended service request message to the Mobility Management Entity (MME), immediately performs handover to the different system, and handles the voice call. After the voice call is ended, the user equipment may have to perform cell reselection in the different system and then reselect an LTE cell. Frequent execution of such process may impose unnecessary burden on the user equipment.

Hence, a scheme is needed that enables a user equipment, which is being served by a 3G cell conforming to a specification prior to the Release-8 specification, to efficiently select a suitable LTE cell as the target for handover. Here, this scheme is applicable not only to cases involving an LTE system and a 3G system prior to the Release-8 specification but also to cases involving two different types of systems.

### SUMMARY OF THE INVENTION

An aspect of the present invention is to address at least the above-mentioned problems and/or disadvantages and to provide at least the advantages described below. Accordingly, an aspect of the present invention is to provide a method that enables a user equipment supporting different mobile communication systems to effectively perform cell selection.

In accordance with an aspect of the present invention, a cell selection method for a user equipment supporting first and second systems is provided. The method includes storing records of services received by the user equipment in a service log, receiving, by the user equipment, a service from a reference cell of the first system, extracting, by the user equipment which waits to receive a service from the second system during service reception from the reference cell, a cell frequency band of the second system corresponding to identification information of the reference cell from the service log, and performing, when extraction of a cell frequency band of the second system is successful, cell acquisition using the extracted cell frequency band.

In accordance with another aspect of the present invention, a user equipment supporting first and second systems is provided. The equipment includes a first communication unit for communicating with the first system, a second communication unit for communicating with the second system, a storage unit for storing records of services received by the user equipment from the first and second systems in a service log, and a control unit for extracting, to receive a service from the second system during service reception from a reference cell of the first system, a cell frequency band of the second system corresponding to identification information of the reference cell from the service log. When extraction of a cell frequency band of the second system is successful, the second communication unit performs cell acquisition using the extracted cell frequency band.

In accordance with another aspect of the present invention, a cell selection method for a user equipment supporting first and second systems is provided. The method includes creating a table of mappings between cell identification information of the first system and cell frequency bands of the second system, receiving, by the user equipment, a service from a reference cell of the first system, extracting, by the user equipment which waits to receive a service from the second system during service reception from the reference cell, a cell frequency band of the second system corresponding to identification information of the reference cell from the mapping table, and performing, when extraction of the cell frequency band of the second system is successful, cell acquisition using the extracted cell frequency band.

In a feature of the present invention, a user equipment supporting different mobile communication systems can perform cell selection in an effective manner.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspect, features, and advantages of certain exemplary embodiments of the present invention will be more apparent from the following description taken in conjunction with the accompanying drawings, in which:

FIG. 1 illustrates a configuration of a mobile network system involving two different systems according to an exemplary embodiment of the present invention;

FIG. 2 is a block diagram of a user equipment according to an exemplary embodiment of the present invention;

FIG. 3 is a flowchart of a cell selection method for a user equipment according to an exemplary embodiment of the present invention;

FIG. 4 is a flowchart of a cell selection method according to another exemplary embodiment of the present invention; and

FIG. 5 is a flowchart of a cell selection method according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

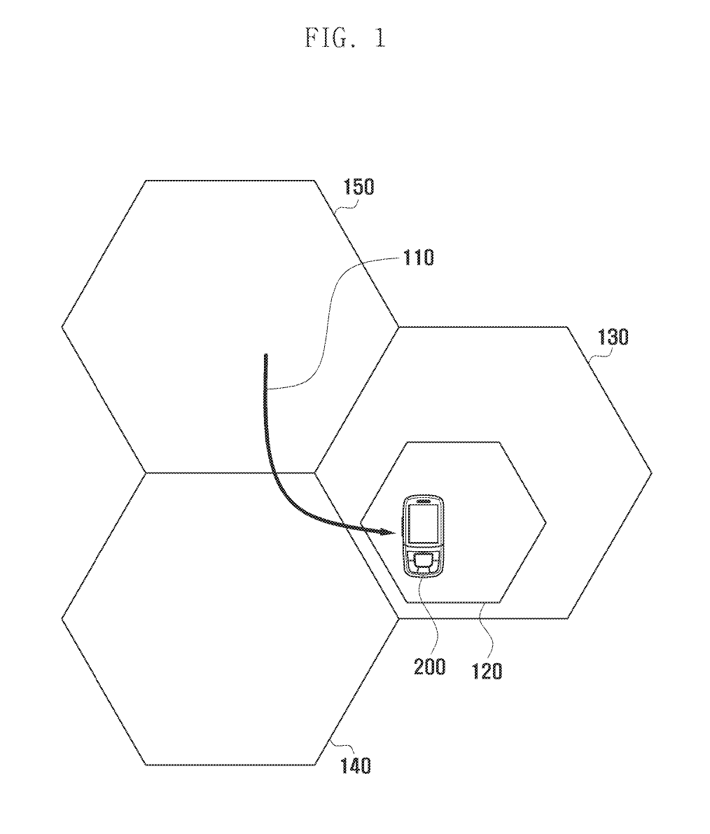

FIG. 1 illustrates a configuration of a mobile network system involving two different systems according to an exemplary embodiment of the present invention.

Referring to FIG. 1, the mobile network system includes a set of deployed cells 120, 130, 140, and 150. A first cell 130 belongs to a first system, and second to fourth cells 120, 140 and 150 belong to a second system. Here, it is assumed that the first system is a 3rd Generation (3G) system and the second system is a Long Term Evolution (LTE) system.

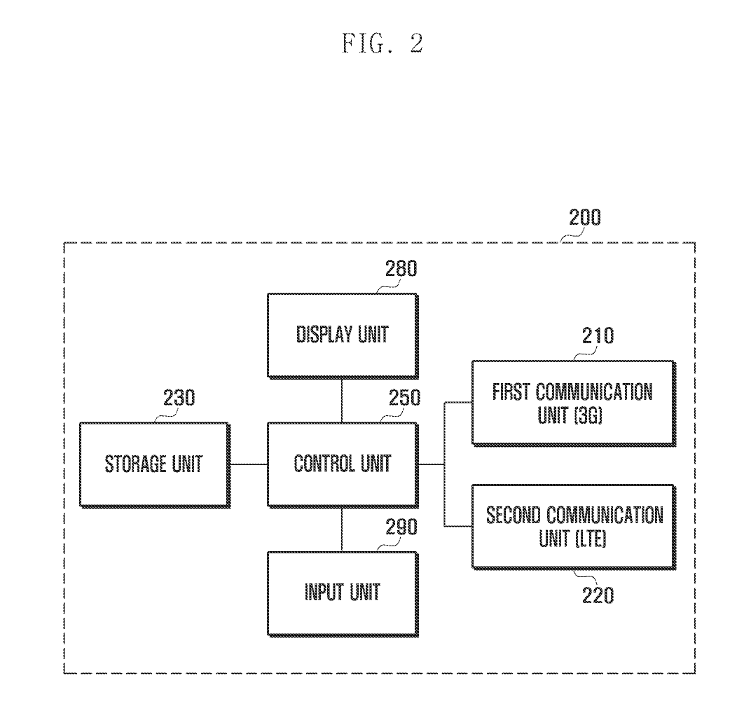

As indicated by a path 110, a user equipment 200 moves from the fourth cell 150 via the third cell 140 and the first cell 130 to a region covered by both the second cell 120 and the first cell 130. Entering the region covered by both the second cell 120 and the first cell 130, the user equipment 200 is served by the second cell 120, an LTE cell. When a call request is received from the 3G system, the user equipment 200 terminates a connection to the second cell 120 and receives a call service from the first cell 130. After the call ends, the user equipment 200 selects an LTE cell to receive a service from the LTE system. In this scenario, the user equipment 200 is highly likely to remain in the region covered by both the second cell 120 and the first cell 130 during and after the call. Hence, it may be effective for the user equipment 200 to first attempt to acquire a frequency band from the second cell 120 for cell selection. This cell selection method is described in detail with reference to FIGS. 2 to 5.

FIG. 2 is a block diagram of a user equipment according to an exemplary embodiment of the present invention.

Referring to FIG. 2, the user equipment 200 includes a first communication unit 210, a second communication unit 220, a storage unit 230, a control unit 250, a display unit 280, and an input unit 290.

The first communication unit 210 communicates with a first system, and the second communication unit 220 communicates with a second system. As described above, the first system may be a 3G system and the second system may be an LTE system. The first communication unit 210 may communicate with a 3G cell to provide the user with services such as a call service and Internet access service. The second communication unit 220 may communicate with an LTE cell to provide the user with services such as a call service and Internet access service. The first communication unit 210 may receive identification information of a neighbor cell of the current cell (or reference cell). Cell identification information is described below. In the description, the reference cell refers to a cell that currently provides services to the user equipment 200.

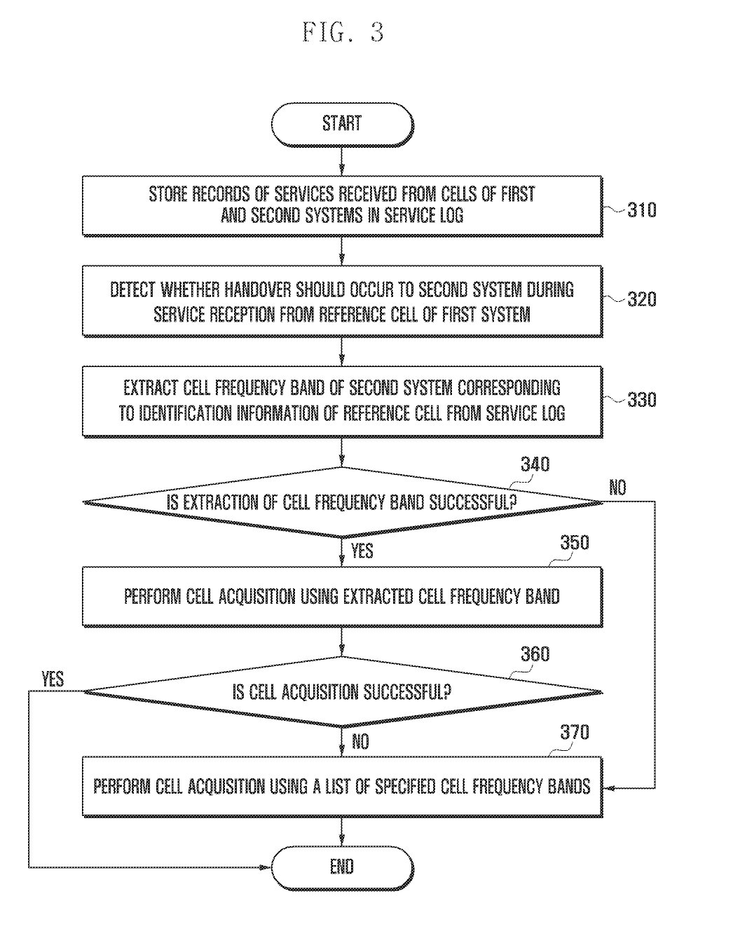

The storage unit 230 may store a log of services received from cells of the first system (3G) and second system (LTE). A service log may include identification information of cells (from which the user equipment 200 has received services) and frequency bands of the second system (which have been used to provide services to the user equipment 200). The format of a service log is described in connection with FIGS. 3 to 5.

To receive a service from the second system while being served by the reference cell of the first system, the control unit 250 obtains the frequency band of a cell of the second system corresponding to the identification information of the reference cell using a service log stored in the storage unit 230. Here, the cell identification information is used to distinguish cells. For example, Primary Scrambling Codes (PSC) and other cell-specific information may be used as cell identification information. In the following description, primary scrambling codes are used as cell identification information. The frequency band of a cell of the second system corresponding to identification information of the reference cell refers to the frequency band assigned to a cell of the second system that is expected to overlap with the reference cell.

In an exemplary embodiment, when a first record of the service log having the identification information of the reference cell of the first system is adjacent to a second record having the frequency band of a cell of the second system, the control unit 250 may extract the frequency band of the cell of the second system from the second record as the frequency band corresponding to the identification information of the reference cell.

In another exemplary embodiment, when a first record of the service log related to a first cell of the first system is adjacent to a second record related to a second cell of the second system, the control unit 250 may extract the frequency band of the second cell from the second record as the frequency band corresponding to the identification information of the first cell, obtain information on a mapping between cell identification information of the first system and the cell frequency band of the second system, and obtain the cell frequency band of the second system corresponding to the identification information of the reference cell using the mapping information.

When extraction of a cell frequency band of the second system fails or an attempt to acquire an extracted cell frequency band of the second system fails, the control unit 250 may extract a cell frequency band of the second system corresponding to the identification information of a neighbor cell (received through the first communication unit 210) using a procedure similar to that depicted above. Alternatively, the control unit 250 may control the second communication unit 220 to try to obtain a cell frequency band of the second system corresponding to the identification information of a neighbor cell.

A detailed description will be given of the first communication unit 210, second communication unit 220, storage unit 230 and control unit 250 later in connection with FIGS. 3 to 5.

The input unit 290 receives a control input from the user and forwards the received control input to the control unit 250, which then controls the user equipment 200 according to the received control input. The input unit 290 may include a keypad and a touch screen to receive user input.

The display unit 280 provides status information of the user equipment 200 and other information to the user. The display unit 280 may be realized using conventional means such as a liquid crystal display device to convey visual information to the user.

As the display unit 280 and the input unit 290 are not directly related to the subject matter of the present invention, detailed descriptions thereof are omitted.

FIG. 3 is a flowchart of a cell selection method for a user equipment according to an exemplary embodiment of the present invention.

Referring to FIG. 3, the control unit 250 of the user equipment 200 controls the storage unit 230 to store records of services received from cells of the first and second systems in a service log at step 310. The service log may contain identification information of a cell of the first system from which the user equipment 200 has received service, and a frequency band of the second system that has been used to provide a service to the user equipment 200.

Table 1 illustrates an example of a service log containing records of services received by the user equipment 200.

TABLE 1

| | Cell identification | | | |
|---|---|---|---|---|
| Sequence | information | Frequency | Service | Service |
| number | (i.e., PSC) | band | start | end |
| 1 | PSC 4 | | 04/06 08:24 | 04/06 18:26 |
| 2 | PSC 3 | | 04/06 18:26 | 04/06 18:30 |
| 3 | PSC 1 | | 04/06 18:30 | 04/06 18:35 |
| 4 | | Band 2 | 04/06 18:35 | 04/06 18:40 |
| 5 | PSC 1 | | 04/06 18:40 | — |

Table 1 illustrates a service log stored in the storage unit, which contains records of services received while the user equipment 200 has moved along the path 110 in FIG. 1. The service log shows: the user equipment 200 received service from the fourth cell 150, and the identification information of the fourth cell 150 (PSC 4) was stored as a record in the service log (sequence number 1); the user equipment 200 received a service from the third cell 140, and the identification information of the third cell 140 (PSC 3) was stored as a record (sequence number 2); the user equipment 200 received a service from the first cell 130, and the identification information of the first cell 130 (PSC 1) was stored as a record (sequence number 3); the user equipment 200 received a service from the second cell 120 (an LTE cell of the second system) (sequence number 4); and, in response to a voice call request from the first system (3G) during service reception from the second cell 120, the user equipment 200 was handed over to the first system to receive service from the first cell 130, and the identification information of the first cell 130 (PSC 1) was stored as a record (sequence number 5). Here, the last cell the user equipment 200 has visited is the first cell 130.

Table 2 illustrates another example of a service log containing records of services received by the user equipment 200.

TABLE 2

| Sequence | Cell identification | Frequency |
|---|---|---|
| number | information (i.e., PSC) | band |
| 1 | PSC 4 | |
| 2 | PSC 3 | |
| 3 | PSC 1 | |
| 4 | | Band 2 |
| 5 | PSC 1 | |

Table 2 is similar to Table 1, but it does not contain service start and stop times. It is assumed in this example that sequence numbers are assigned with the passage of time.

To save storage space for the service log (such as Table 1 or Table 2), some entries of the service log may be deleted, oldest first.

The control unit 250 detects whether a handover to the second system during service reception from the reference cell should occur at step 320. Here, as described above, the reference cell refers to the cell from which the user equipment 200 currently receives a service. For example, when the user equipment 200 enters a region covered by a first cell 130 (3G) and receives a voice call service from the first cell 130, the first cell 130 is the reference cell. Later, when the voice call is ended, the user equipment 200 may attempt to receive service from an LTE cell of the second system. There may be other reasons for handover to the second system.

For handover to the second system, the control unit 250 extracts a cell frequency band corresponding to the identification information of the reference cell from the service log as shown in Table 1 or Table 2 at step 330. As described above, the current reference cell in this example is the first cell 130, whose identification information is “PSC 1”. The cell frequency band corresponding to the identification information of the reference cell refers to the frequency band assigned to a cell that is expected to overlap with the reference cell.

Two cells of different systems whose service records are adjacent in the service log have a high probability of overlapping each other. For example, in Table 1 or Table 2, a record (sequence number 3 or 5) containing “PSC 1” as cell identification information is adjacent to another entry (sequence number 4) containing “Band 2” as a cell frequency band. Hence, the cell frequency band corresponding to the identification information of the reference cell may be “Band 2”.

In other words, when a first record of the service log containing the identification information (PSC 1) of the reference cell (first cell 130) of the first system is adjacent to a second record containing the frequency band of a cell (second cell 120) of the second system, the control unit 250 may extract the frequency band of the second cell 120 from the second record as the frequency band corresponding to the identification information of the first cell 130.

Adjacency between service records of a service log may be determined in several ways according to the exemplary embodiments.

First, when a first record indicates that the user equipment received a service from a first cell of the first system and a second record indicates that the user equipment received a service from a second cell of the second system within a preset time (for example, 1 second) after the service from the first cell ended, the first record and the second record may be considered to be adjacent in the service log. When the preset time is sufficiently short, the first record and the second record may indicate occurrence of handover from the first cell to the second cell. When the preset time is not too long, the first record and the second record may also be considered adjacent. In this exemplary embodiment, service start and end times should be recorded in the service log as in Table 1.

Second, when a first record indicates that the user equipment received service from a second cell of the second system and a second record indicates that the user equipment received service from a first cell of the first system within a preset time (for example, 1 second) after the service from the second cell ended, the first record and the second record may be considered adjacent in the service log. The description given to the first case may also be applied to the second case. The first case and the second case may be utilized together.

Third, this case may be applied when the user equipment is allowed to access the first system and the second system at the same time. When a first record and a second record indicate that the time at which the user equipment received a service from a first cell of the first system overlaps with the time at which the user equipment received a service from a second cell of the second system, the first record and the second record may be considered to be adjacent in the service log.

Fourth, when no record is present between a first record indicating service reception from a first cell of the first system and a second record indicating service reception from a second cell of the second system, the first record and the second record may be considered to be adjacent in the service log. In this exemplary embodiment, it is unnecessary to record service start and end times in the service log as in Table 1. It is sufficient to keep the order of service records as in Table 2.

Fifth, when no record is present between a first record indicating service reception from a second cell of the second system and a second record indicating service reception from a first cell of the first system, the first record and the second record may be considered to be adjacent in the service log. The description given to the fourth case may also be applied to the fifth case. The fourth case and the fifth case may be utilized together.

The control unit 250 may determine the cell frequency band of the second system corresponding to the identification information of the reference cell using two or more of the first to fifth schemes for adjacency determination as described above.

In the above description, when it is detected that a handover from the first system to the second system should occur, the control unit 250 determines the cell frequency band of the second system corresponding to the current reference cell by referring to a service log as illustrated in Table 1 or Table 2. Alternatively, a table of mappings between cell identification information of the first system and cell frequency bands of the second system may be created first, and the cell frequency band of the second system corresponding to the identification information of the reference cell may be determined using the mapping table.

For example, using a service log as illustrated in Table 2, a table of mappings between cell identification information of the first system and cell frequency bands of the second system can be created as in Table 3. In this example, the fourth and fifth adjacency determination schemes are utilized together.

TABLE 3

| Cell identification | Frequency |
|---|---|
| information (i.e., PSC) | band |
| PSC 1 | Band 2 |

As Table 2 is simple, only one mapping is extracted as in Table 3. A more realistic example is described below.

Table 4 illustrates another example of a service log containing records of services received by the user equipment 200.

TABLE 4

| Sequence | Cell identification | Frequency |
|---|---|---|
| number | information (i.e., PSC) | band |
| 1 | PSC 4 | |
| 2 | | Band 5 |
| 3 | PSC 7 | |
| 4 | | Band 2 |
| 5 | PSC 1 | |
| 6 | PSC 3 | |
| 7 | | Band 6 |
| 8 | PSC 1 | |

Table 5 illustrates a mapping table created using records of Table 4. In this example, the fourth and fifth adjacency determination schemes are utilized together. That is, when no record is present between first and second records indicating service reception from the first system and the second system, the first and second records are considered adjacent.

TABLE 5

| Cell identification | Frequency |
|---|---|
| information (i.e., PSC) | band |
| PSC 4 | Band 5 |
| PSC 7 | Band 2, Band 5 |
| PSC 1 | Band 6, Band 2 |
| PSC 3 | Band 6 |

As indicated by Table 5, one PSC may correspond to more than one frequency band. In Table 4, the records of sequence numbers 5 and 8 are related to service reception from a cell identified by “PSC 1”. The record of sequence number 4 having “Band 2” is adjacent to the record of sequence numbers 5, and the record of sequence number 7 having “Band 6” is adjacent to the record of sequence numbers 8. Hence, two frequency bands “Band 6” and “Band 2” are extracted as a frequency band corresponding to the cell identification information “PSC 1”.

Such a mapping table may be created when the control unit 250 detects that a handover should occur.

Storage space for the mapping table may be saved by deleting old entries and adding new entries based on updated service records. Additional storage space may be freed by deleting service records used to create a mapping table.

When the identification information of the reference cell is “PSC 1”, “Band 6” and “Band 2” are extracted, using the mapping table of Table 5, as the cell frequency band of the second system corresponding to the identification information of the reference cell.

The control unit 250 determines whether extraction of a cell frequency band is successful at step 340. In the above description, extraction of a cell frequency band is assumed to be successful. When extraction of a cell frequency band is unsuccessful, the control unit 250 proceeds to step 370 and performs cell acquisition using a list of specified cell frequency bands. In the service log of Table 1, if the identification information of the reference cell is “PSC 4”, no record related to the second system is adjacent to the record containing “PSC 4” and hence extraction of a cell frequency band fails.

At step 340, referring to Table 1 and Table 2, when the identification information of the reference cell is “PSC 1”, the cell frequency band corresponding to “PSC 1” is “Band 2”. Hence, extraction of a cell frequency band is successful and the control unit 250 proceeds to step 350.

When extraction of a cell frequency band is successful, the control unit 250 controls the second communication unit 220 to perform cell acquisition using the extracted cell frequency band (for example, “Band 2”) at step 350. The procedure of LTE cell acquisition is known to those skilled in the art, and a detailed description thereof will be omitted.

In the case of multiple cell frequency bands as in Table 4 or Table 5, the cell frequency band relating to the latest service record is selected. For example, in Table 4 or Table 5, two frequency bands “Band 2” and “Band 6” correspond to “PSC 1”. As the record containing “Band 6” is created later than that containing “Band 2”, the second communication unit 220 performs cell acquisition using “Band 6” first. When cell acquisition using “Band 6” fails, cell acquisition using “Band 2” may be performed.

The control unit 250 checks whether cell acquisition using the extracted cell frequency band is successful at step 360. Referring to FIG. 1, when the user equipment 200 remains in a region covered by both the second cell 120 and the first cell 130, cell acquisition using “Band 2” will succeed; and when the user equipment 200 moves to a region covered by the first cell 130 but not covered by the second cell 120, cell acquisition using “Band 2” will fail. When cell acquisition using the extracted cell frequency band is successful, the control unit 250 may perform handover to the acquired cell. When cell acquisition using the extracted cell frequency band is unsuccessful, the control unit 250 performs cell acquisition using a list of specified cell frequency bands according to an existing approach at step 370.

As described above, the cell selection method depicted in FIG. 3 uses a service log containing records of services received by the user equipment 200 to acquire an LTE cell using first a frequency band related to a record adjacent to a record related to the current reference cell.

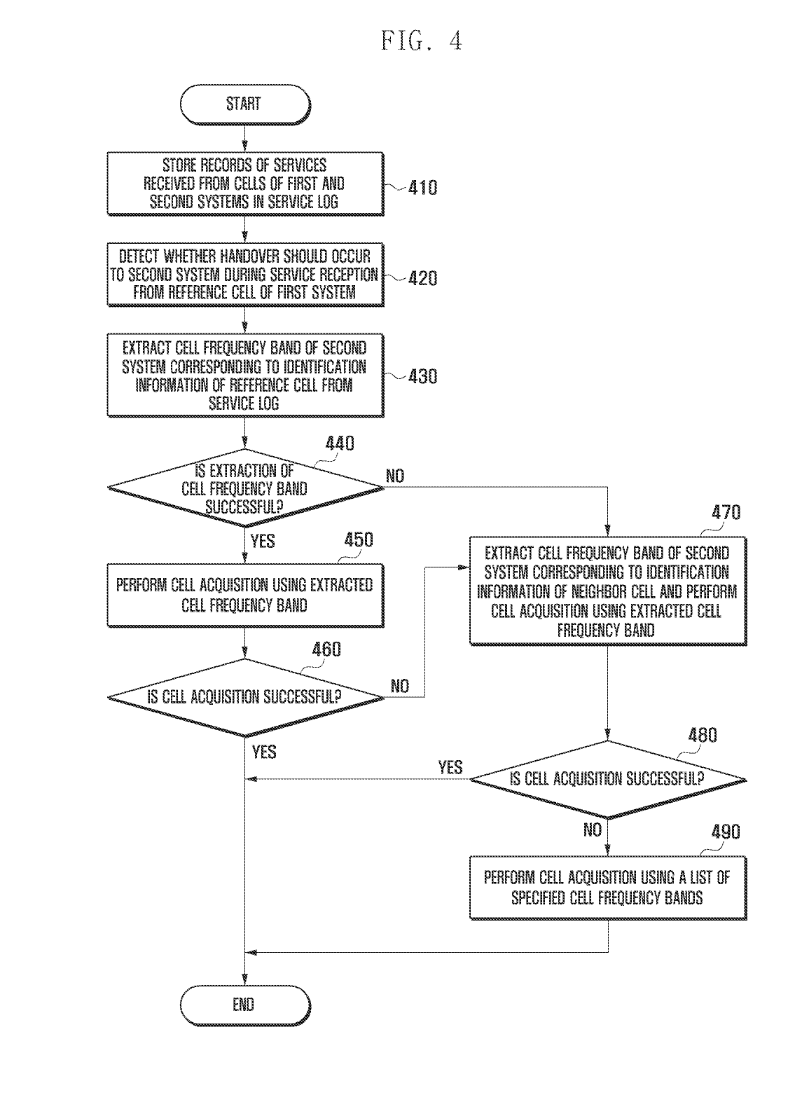

FIG. 4 is a flowchart of a cell selection method according to another exemplary embodiment of the present invention.

Referring to FIG. 4, steps 410, 420 and 430 correspond respectively to steps 310, 320 and 330 of FIG. 3, and a detailed description thereof is omitted.

The control unit 250 determines whether extraction of a cell frequency band of the second system corresponding to the identification information of the reference cell is successful at step 440. When extraction of a cell frequency band is successful, the control unit 250 controls the second communication unit 220 to perform cell acquisition using the extracted cell frequency band at step 450. The control unit 250 checks whether cell acquisition using the extracted cell frequency band is successful at step 460. When cell acquisition using the extracted cell frequency band is successful, the control unit 250 may perform handover to the acquired cell, ending cell selection. When extraction of a cell frequency band is unsuccessful at step 440 or cell acquisition using the extracted cell frequency band is unsuccessful at step 460, the control unit 250 proceeds to step 470.

The control unit 250 extracts a cell frequency band of the second system corresponding to the identification information of a neighbor cell (in the first system) of the reference cell and performs cell acquisition using the extracted cell frequency band at step 470. The first communication unit 210 may receive identification information of a neighbor cell from the reference cell. For example, in FIG. 1, the first cell 130 may send identification information (i.e, PSC) of its neighbor cells (third cell 140 and fourth cell 150) to the first communication unit 210, which forwards the received identification information to the control unit 250. The control unit 250 may extract a cell frequency band of the second system corresponding to the identification information of the third cell 140 or the fourth cell 150 using a procedure similar to that described at step 330 of FIG. 3. When extraction of a cell frequency band is successful, the control unit 250 performs cell acquisition using the extracted cell frequency band. When cell acquisition using the extracted cell frequency band is successful at step 480, the control unit 250 may perform handover to the acquired cell, ending cell selection. When extraction of a cell frequency band corresponding to a neighbor cell is unsuccessful at step 470 or cell acquisition using the extracted cell frequency band corresponding to the neighbor cell is unsuccessful at step 480, the control unit 250 performs cell acquisition using a list of specified cell frequency bands at step 490.

In the cell selection method of FIG. 4, when a cell frequency band of the second system corresponding to the reference cell is not found, a cell frequency band of the second system corresponding to a neighbor cell of the reference cell is found for cell acquisition. This may contribute to effective cell selection because a cell overlapping with the reference cell is likely to overlap with a neighbor cell of the reference cell.

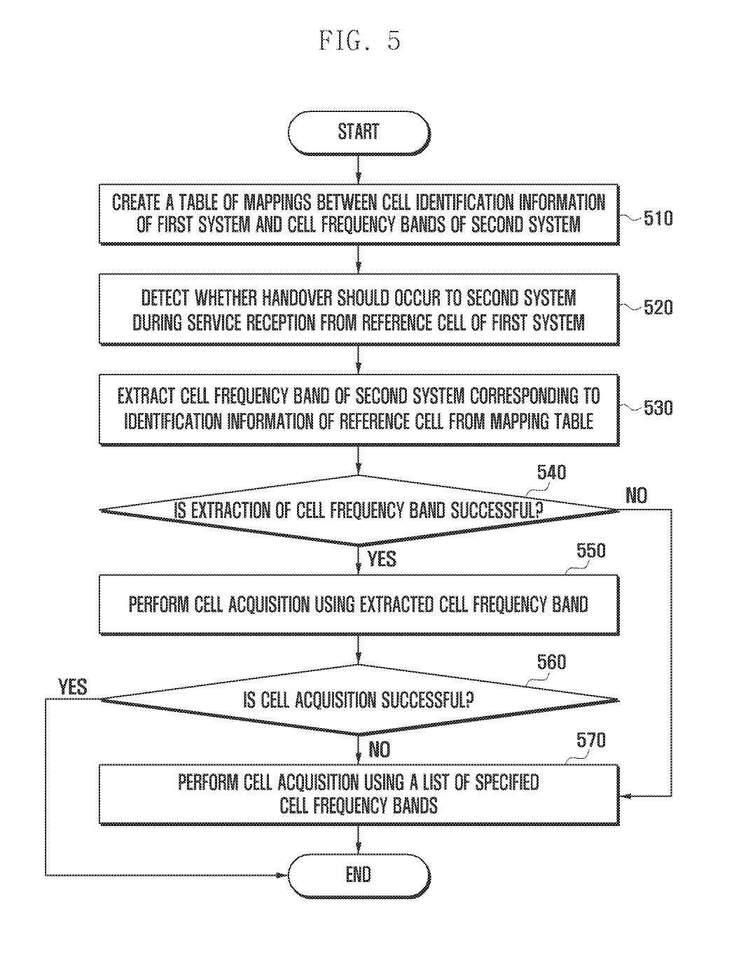

FIG. 5 is a flowchart of a cell selection method according to another exemplary embodiment of the present invention.

In the method of FIG. 5, mappings between cell identification information of the first system and cell frequency bands of the second system are prepared first; and when it is detected that a handover from the first system to the second system should occur, the frequency band of a cell that is expected to overlap with the reference cell is extracted using the mappings.

Referring to FIG. 5, the control unit 250 of the user equipment 200 creates a table of mappings between cell identification information of the first system and cell frequency bands of the second system at step 510.

The mapping table may be updated when an inter-system handover (from the first system to the second system or from the second system to the first system) occurs. For example, referring to Table 4, when a handover from a cell related to the record of sequence number 1 to a cell related to the record of sequence number 2 occurs, a mapping between cell identification information “PSC 4” and a cell frequency band “Band 5” is added to the mapping table; and when a handover from a cell related to the record of sequence number 2 to a cell related to the record of sequence number 3 occurs, a mapping between cell identification information “PSC 7” and a cell frequency band “Band 5” is added to the mapping table. The mapping table may be stored in the storage unit 230.

In this exemplary embodiment, it is not necessary to store all records of services received by the user equipment 200. The mapping table need only be updated as in Table 3 or Table 5 when an inter-system handover occurs, and can then be used for cell selection.

The control unit 250 detects that a handover to the second system during service reception from the reference cell should occur at step 520. Step 520 is the same as step 320 of FIG. 3, and a description thereof is omitted.

The control unit 250 extracts a cell frequency band corresponding to the identification information of the reference cell from the mapping table at step 530. For example, referring to Table 3, when the identification information of the reference cell is “PSC 1”, “Band 2” is extracted as a corresponding cell frequency band.

Steps 540, 550, 560 and 570 are identical respectively to steps 340, 350, 360 and 370 of FIG. 3, and a detailed description thereof is omitted. Steps 540 and subsequent steps may be replaced with steps 440, 450, 460, 470, 480 and 490 of FIG. 4.

It is known to those skilled in the art that blocks of a flow chart and a combination of flowcharts may be represented and executed by computer program instructions. These computer program instructions may be loaded on a processor of a general purpose computer, a special computer or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out the steps of the functions described in the flowchart.

A block of a flowchart may correspond to a module, a segment, or a code containing one or more executable instructions implementing one or more logical functions, or to a part thereof. In some cases, functions described by blocks may be executed in an order different from the listed order. For example, two blocks listed in sequence may be executed at the same time or executed in reverse order.

In the present disclosure, the word “unit”, “module” or the like may refer to a software component or hardware component such as an Field Programmable Gate Array (FPGA) or Application-Specific Integrated Circuit (ASIC) capable of carrying out a function or an operation. However, a word such as “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units. Components and units may be configured to drive a device or one or more processors in a secure multimedia card.

The description of the various embodiments is to be construed as exemplary only and does not describe every possible instance of the invention. Therefore, it should be understood that various changes may be made and equivalents may be substituted for elements of the invention.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A cell selection method for a user equipment supporting first and second systems, the method comprising:
storing records of services received by the user equipment in a service log;
receiving, by the user equipment, a service from a reference cell of the first system;
extracting, by the user equipment which waits to receive a service from the second system during service reception from the reference cell, a cell frequency band of the second system corresponding to identification information of the reference cell from the service log; and
performing, when extraction of a cell frequency band of the second system is successful, cell acquisition using the extracted cell frequency band.

2. The method of claim 1, wherein the extracting of the cell frequency band of the second system comprises:
extracting, when a first record of the service log related to a first cell of the first system is adjacent to a second record related to a second cell of the second system, the frequency band of the second cell from the second record as the frequency band corresponding to the identification information of the first cell, and creating a table of mappings between cell identification information of the first system and cell frequency bands of the second system; and
extracting a cell frequency band of the second system corresponding to identification information of the reference cell from the mapping table.

3. The method of claim 1, wherein the extracting of the cell frequency band of the second system comprises extracting, when a first record of the service log comprising identification information of the reference cell of the first system is adjacent to a second record having a frequency band of a cell of the second system, the frequency band of the cell of the second system from the second record as the frequency band corresponding to the identification information of the reference cell.

4. The method of claim 1, wherein the records comprise a record containing identification information of a cell of the first system having provided a service to the user equipment and a record containing a frequency band of a cell of the second system having provided a service to the user equipment.

5. The method of claim 1, further comprising:
receiving identification information of a neighbor cell of the reference cell; and
extracting, when extraction of the cell frequency band of the second system corresponding to the reference cell fails, a cell frequency band of the second system corresponding to the identification information of the neighbor cell, and performing cell acquisition using the extracted cell frequency band corresponding to the neighbor cell.

6. The method of claim 1, further comprising:
receiving identification information of a neighbor cell of the reference cell; and
extracting, when cell acquisition using the extracted cell frequency band corresponding to the reference cell fails, a cell frequency band of the second system corresponding to the identification information of the neighbor cell, and performing cell acquisition using the extracted cell frequency band corresponding to the neighbor cell.

7. The method of claim 1, wherein the identification information of a cell of the first system comprises a Primary Scrambling Code (PSC).

8. A user equipment supporting first and second systems, the user equipment comprising:
a first communication unit for communicating with the first system;
a second communication unit for communicating with the second system;
a storage unit for storing records of services received by the user equipment from the first and second systems in a service log; and
a control unit for extracting, to receive a service from the second system during service reception from a reference cell of the first system, a cell frequency band of the second system corresponding to identification information of the reference cell from the service log,
wherein the second communication unit performs, when the extraction of the cell frequency band of the second system is successful, cell acquisition using the extracted cell frequency band.

9. The user equipment of claim 8, wherein the control unit extracts, when a first record of the service log related to a first cell of the first system is adjacent to a second record related to a second cell of the second system, a frequency band of the second cell from the second record as the frequency band corresponding to the identification information of the first cell, creates a table of mappings between cell identification information of the first system and cell frequency bands of the second system, and extracts a cell frequency band of the second system corresponding to identification information of the reference cell from the mapping table.

10. The user equipment of claim 8, wherein the control unit extracts, when a first record of the service log comprising identification information of the reference cell of the first system is adjacent to a second record having a frequency band of a cell of the second system, the frequency band of the cell of the second system from the second record as the frequency band corresponding to the identification information of the reference cell.

11. The user equipment of claim 8, wherein the records comprise a record including identification information of a cell of the first system having provided a service to the user equipment and a record including a frequency band of a cell of the second system having provided a service to the user equipment.

12. The user equipment of claim 8, wherein the first communication unit receives identification information of a neighbor cell of the reference cell, and wherein the control unit extracts, when the extraction of the cell frequency band of the second system corresponding to the reference cell fails, a cell frequency band of the second system corresponding to the identification information of the neighbor cell, and performs cell acquisition using the extracted cell frequency band corresponding to the neighbor cell.

13. The user equipment of claim 8, wherein the first communication unit receives identification information of a neighbor cell of the reference cell, and wherein the control unit extracts, when cell acquisition using the extracted cell frequency band corresponding to the reference cell fails, a cell frequency band of the second system corresponding to the identification information of the neighbor cell, and performs cell acquisition using the extracted cell frequency band corresponding to the neighbor cell.

14. The user equipment of claim 8, wherein the identification information of a cell of the first system comprises a Primary Scrambling Code (PSC).

15. A cell selection method for a user equipment supporting first and second systems, the method comprising:
creating a table of mappings between cell identification information of the first system and cell frequency bands of the second system;
receiving, by the user equipment, a service from a reference cell of the first system;
extracting, by the user equipment which waits to receive a service from the second system during service reception from the reference cell, a cell frequency band of the second system corresponding to identification information of the reference cell from the mapping table; and
performing, when the extraction of the cell frequency band of the second system is successful, cell acquisition using the extracted cell frequency band.
